(19) United States
(12) Patent Application Publication
(10) Pub. No.: US 2011/0309915 A1
(43) Pub. Date: Dec. 22, 2011

(54) CONTROLLER FOR CONTROLLING ILLUMINATION

(75) Inventors: Ho Chan CHO, Suwon-si (KR); Sang Kyeong YUN, Suwon-si (KR); Chang Seob KIM, Seoul (KR)

(73) Assignee: SAMSUNG LED CO., LTD., Suwon-si (KR)

(21) Appl. No.: 13/165,912

(22) Filed: Jun. 22, 2011

(30) Foreign Application Priority Data
Jun. 22, 2010 (KR) 10-2010-0059180

(51) Int. Cl. G08C 19/16

(52) U.S. Cl. 340/12.29

(57) ABSTRACT

Disclosed is a controller for controlling an illumination device participating in a wireless network by setting a scene of illumination according to a configurable schedule. The controller for controlling an illumination device includes: a control unit controlling an illumination scene of an illumination device selected from among a plurality of illumination devices existing in a pre-set network according to a pre-set schedule table; a frame generation unit generating a frame for controlling the illumination scene of the corresponding illumination device under the control of the control unit; and a communication unit transmitting the frame generated by the frame generation unit to the selected illumination device under the control of the controller.

### CROSS-REFERENCE TO RELATED APPLICATIONS

This application claims the priority of Korean Patent Application No. 10-2010-0059180 filed on Jun. 22, 2010, in the Korean Intellectual Property Office, the disclosure of which is incorporated herein by reference.

### BACKGROUND OF THE INVENTION

1. Field of the Invention

The present invention relates to a controller for controlling illumination and, more particularly, to a controller for controlling an illumination device (or a lighting system) participating in a wireless network by setting a scene of illumination according to a configurable schedule.

2. Description of the Related Art

In general, illumination is installed in certain areas such as in the interior of buildings, rooms, classrooms, and the like, for user convenience.

A plurality of illumination devices (or lighting systems) may be installed in a certain area, and a plurality of areas in which a plurality of illumination devices are installed may be formed. In order to control the illumination devices within these areas, generally, switches for controlling supplying or cutting off power to the illumination devices are installed with a fixed line. In this case, in order to control each of the plurality of illumination devices, the same number of switches must be installed, and when a switch is installed to control the plurality of illumination devices as a group, it is difficult to reset the illumination device group.

To solve such a problem, the plurality of illumination devices are included in a network so as to be controlled, but such an illumination control system using a network merely performs dimming controlling in addition to the setting of an illumination device group, failing to meet the consumers' demand for individually controlled illumination devices.

### SUMMARY OF THE INVENTION

An aspect of the present invention provides a controller for controlling an illumination device as part of a wireless network by setting a scene of illumination according to a configurable schedule.

According to an aspect of the present invention, there is provided a controller for controlling an illumination device, including: a control unit controlling an illumination scene of an illumination device selected from among a plurality of illumination devices existing in a pre-set network according to a pre-set schedule table; a frame generation unit generating a frame for controlling the illumination scene of the corresponding illumination device under the control of the control unit; and a communication unit transmitting the frame generated by the frame generation unit to the selected illumination device under the control of the controller.

The frame generation unit may generate a control frame to be transmitted to the selected illumination device, and the control frame may include an STX field indicating the start of the frame, a DataLen field indicating the length of information desired to be delivered, a Data field having information desired to be delivered, a Check Sum field for checking an error, and an ETX field indicating the end of the frame.

The data field may include a Primitive ID including the purpose of transmitting information, a Device Address indicating the address of an illumination device desired to be delivered, a Command having a command to be delivered to the illumination device, and Command Data having data required for the command.

The command may include a setting command, a transmission command, and a control command.

The plurality of devices may include an illumination sensor and a motion sensor, and the setting command may command at least one of setting a parameter for a zone and controlling of the plurality of illumination devices, setting the function of a switch, setting a calibration parameter of the illumination sensor, setting an operation of the motion sensor, and setting a control element of the controller.

The transmission command may command the transmission of at least one of a parameter for a zone and controlling of the plurality of illumination device, a parameter set for a switch, a calibration parameter of the illumination sensor, at least one parameter among setting of an operation of the motion sensor and a control element of the controller, transmission of information regarding a state and the presence or absence of a failure, or transmission of databases of the plurality of devices.

The control command may command at least one of controlling a zone of the plurality of illumination devices and controlling the illumination devices by channels, individually controlling the plurality of illumination devices or controlling the illumination devices by channels, controlling of resetting of the plurality of illumination devices, and controlling illumination scenes of the plurality of illumination devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view showing a wireless network including a controller for controlling illumination according to an exemplary embodiment of the present invention;

FIG. 2 is a schematic block diagram of the controller for controlling illumination according to an exemplary embodiment of the present invention;

FIG. 3 is a schematic view illustrating a frame employed for the controller for controlling illumination according to an exemplary embodiment of the present invention;

FIG. 4 is a schematic view showing data of the frame of FIG. 3;

FIGS. 5 to 7 show examples of commands of the data of FIG. 4; and

FIGS. 8 to 14 show examples of screens and functions displayed by the controller for controlling illumination according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

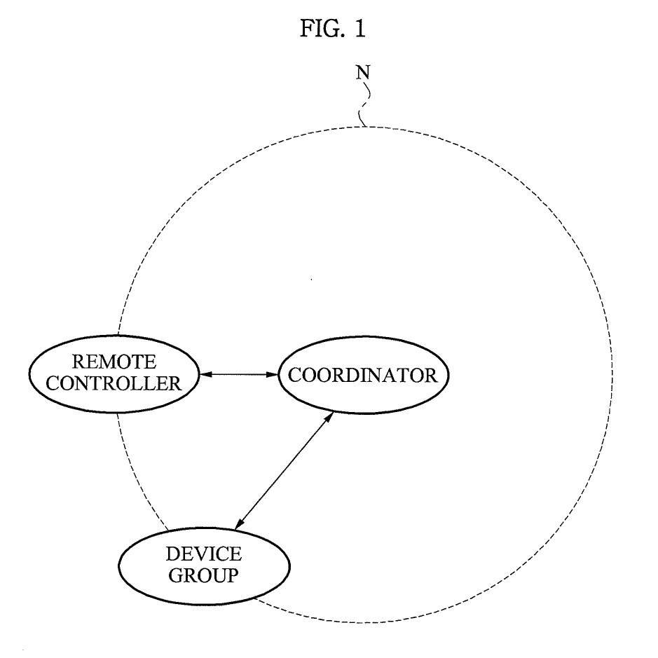

FIG. 1 is a schematic view showing a wireless network including a controller for controlling illumination according to an exemplary embodiment of the present invention.

With reference to FIG. 1, an illumination system wireless network may include a coordinator administering a network, a device group forming a network with the coordinator and performing a pre-set operation, and a controller forming a network with the coordinator and controlling each device of the device group.

The device group may include a plurality of illumination devices that emit light upon receiving power. The device group may further include a motion sensor detecting a motion of the illumination device and an illumination sensor detecting the luminance of the illumination device.

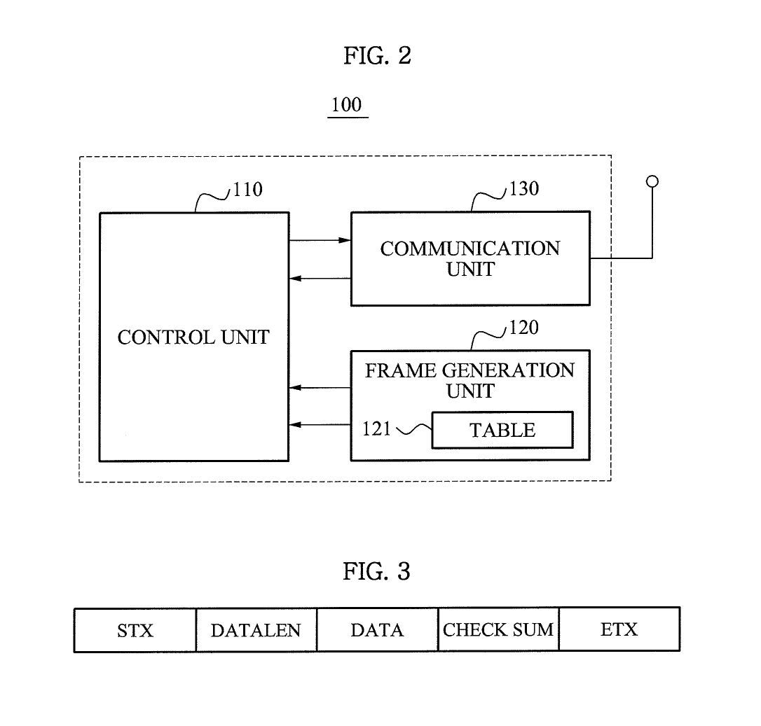

FIG. 2 is a schematic block diagram of the controller for controlling illumination according to an exemplary embodiment of the present invention.

With reference to FIGS. 1 and 2, a controller 100 for controlling illumination may include a control unit 110, a frame generation unit 120, and a communication unit 130.

The control unit 110 may control an illumination scene of a pertinent illumination device, among at least the plurality of illumination devices of the wireless network device group, according to a pre-set schedule table.

The frame generation unit 120 may generate a frame for controlling the illumination scene of the pertinent illumination device under the control of the control unit 110. The communication unit 130 may transmit the frame generated by the frame generation unit 120 to the pertinent illumination device under the control of the control unit 110. The frame may be generated to include a corresponding command with reference to a table 121 of the frame generation unit 120.

FIG. 3 is a schematic view illustrating a frame employed for the controller for controlling illumination according to an exemplary embodiment of the present invention.

With reference to FIG. 3, the frame generation unit 120 generates a control frame to be transmitted to the pertinent illumination device. In this case, the control frame may include an STX field indicating the start of the frame, a DataLen field indicating the length of information desired to be delivered, a Data field having information desired to be delivered, a Check Sum field for checking an error, and an ETX field indicating the end of the frame.

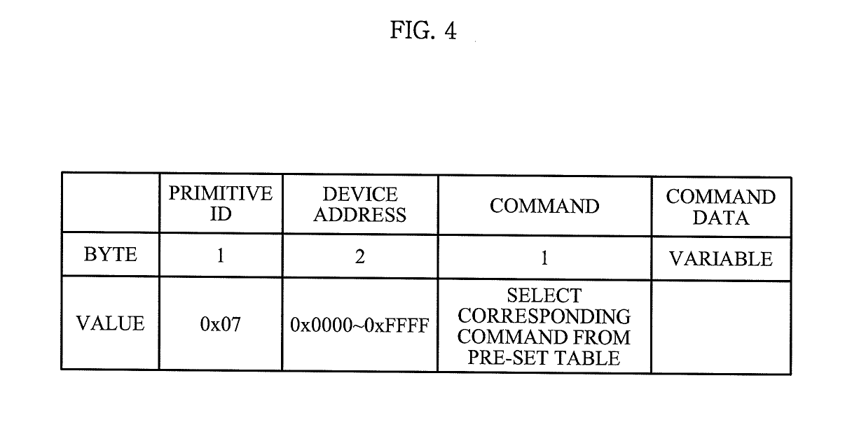

FIG. 4 is a schematic view showing data regarding the frame of FIG. 3.

With reference to FIGS. 3 and 4, the data field may include a Primitive ID including the purpose of transmitting information, a Device Address indicating the address of an illumination device desired to be delivered, a Command having a command to be delivered to the illumination device, and Command Data having data required for the command.

The command included in the Command may include a setting command, a transmission command, and a control command.

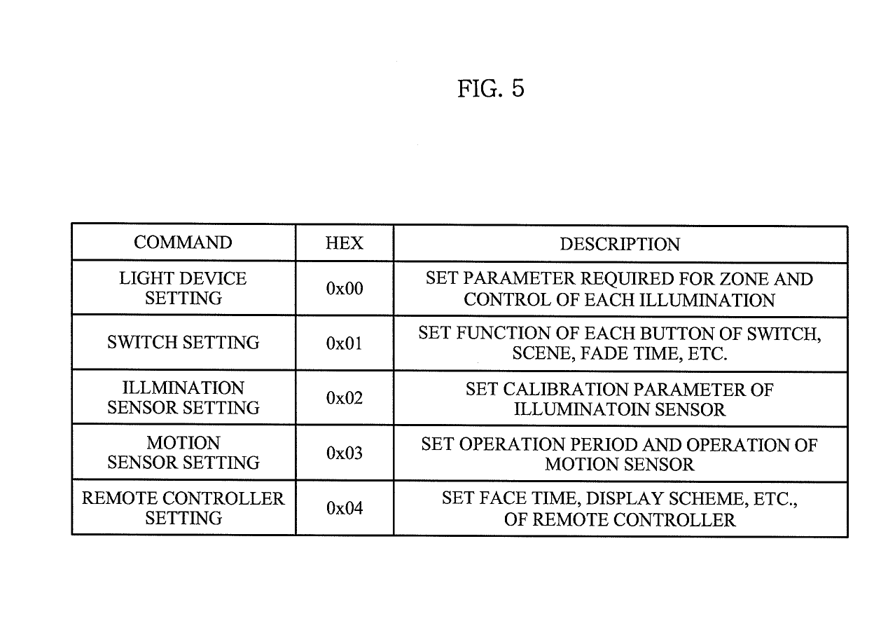

FIGS. 5 to 7 show examples of commands of the data of FIG. 4.

With reference to FIG. 5, the command included in the Command may be a setting command. The setting command may command at least one of setting a parameter (lighting device setting) for a zone of the plurality of illumination devices and controlling the plurality of illumination devices, setting a function of a switch (switch setting), setting a calibration parameter of the illumination sensor (illumination sensor setting), setting an operation of the motion sensor (motion sensor setting), and setting a control element of the controller (remote controller setting). In this case, HEX values may be set to 0X00, 0X01, 0X02, 0X03, and 0X04, respectively.

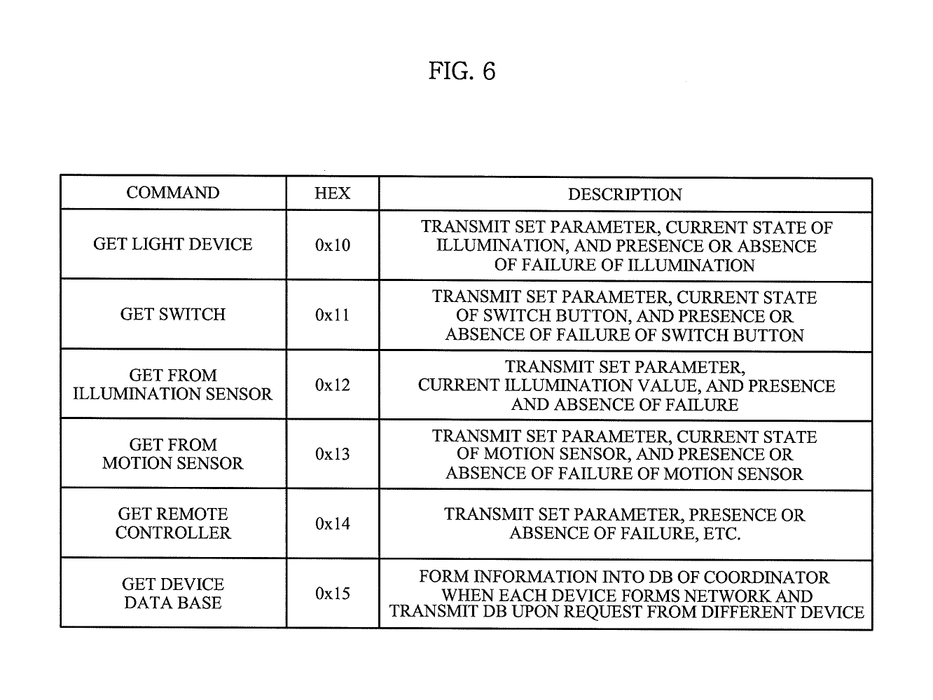

With reference to FIG. 6, the transmission command may command the transmission of at least one of a parameter for a zone of the plurality of illumination devices and for controlling the plurality of illumination devices, an illumination state and the presence or absence of a failure (Get Lighting Device), a calibration parameter of the illumination sensor (Get From Illumination Sensor), a parameter, state of the operation of the motion sensor and a control element of the controller, and the presence or absence of a failure (Get From Motion Sensor, Get Remote Controller), and a database of a device.

In this case, HEX values may be set to 0X10, 0X11, 0X12, 0X13, 0X14, and 0X15, respectively.

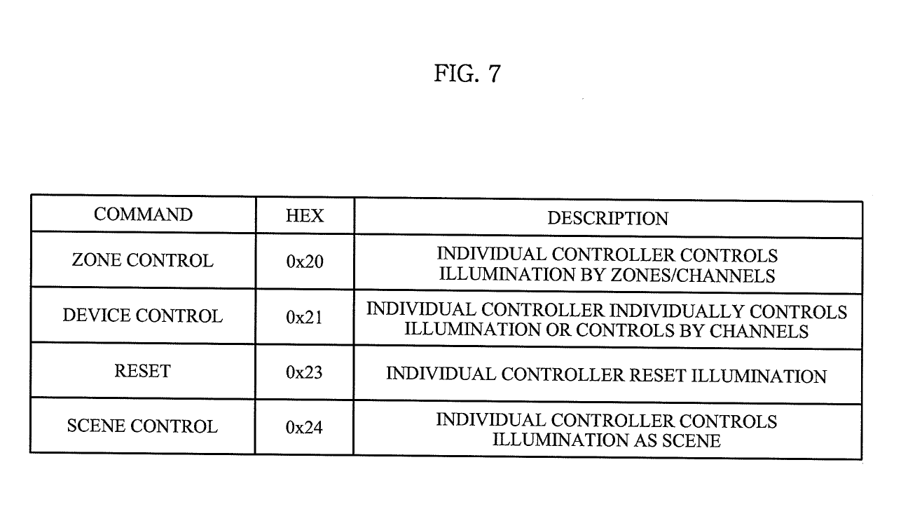

With reference to FIG. 7, the control command may command at least one of controlling a zone and channels of the plurality of illumination devices (Zone Control), individually controlling the plurality of illumination devices or controlling the plurality of illumination devices by channels (Device Control), controlling of resetting of the plurality of illumination devices (Reset), and controlling illumination scenes of the plurality of illumination devices (Scene Control).

In this case, HEX value may be set to 0X20, 0X21, 00X23, and 0X24, respectively.

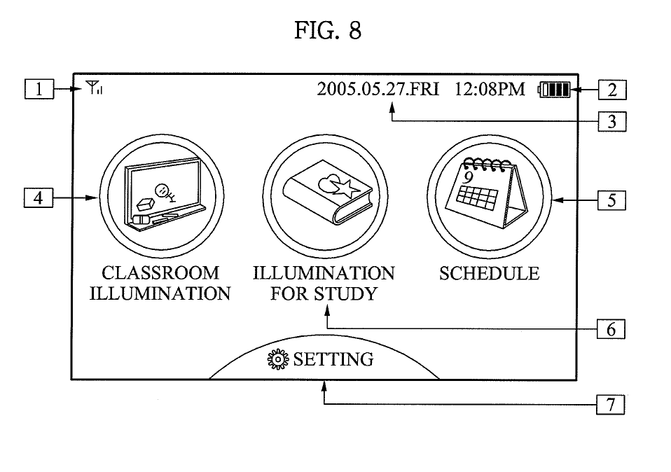

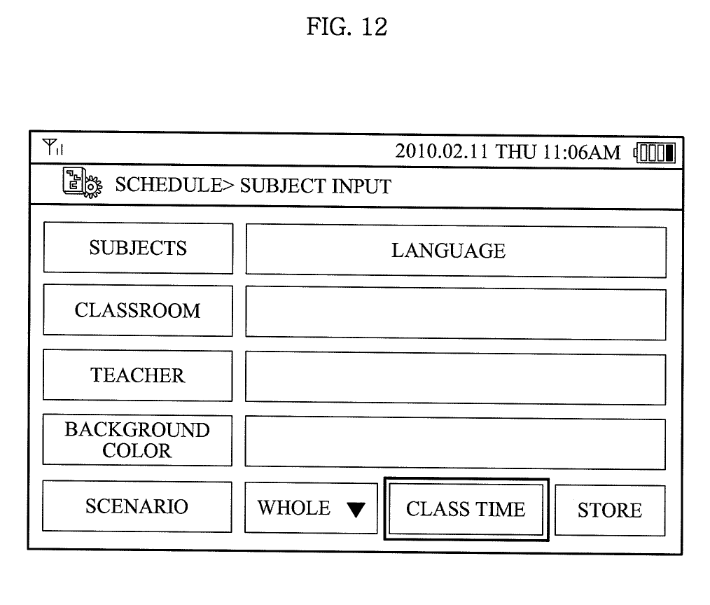

FIGS. 8 to 14 show examples of screens and functions displayed by the controller for controlling illumination according to an exemplary embodiment of the present invention.

FIG. 8 is an initial screen image displayed when the controller for controlling illumination according to an exemplary embodiment of the present invention is operated. With reference to FIG. 8, when Class/Learning, Schedule, and Setting are selected, a current screen image is changed to the corresponding screen image (namely, a corresponding screen is displayed).

Here, identification number 1 denotes an antenna level indicating a current radio reception state. Identification number 2 denotes a battery level indicating a remaining battery capacity of the controller for controlling illumination. Identification number 3 denotes a current time. Identification number 4 denotes alteration to a class illumination screen image when class illumination is controlled and executed. Identification number 5 denotes alteration to a schedule screen image for setting a schedule and controlling an illumination device fitting a corresponding subject. Identification number 6 denotes an alteration to a learning illumination screen image when it is executed to control learning illumination. Identification number 7 denotes setting an environment of the controller for controlling illumination.

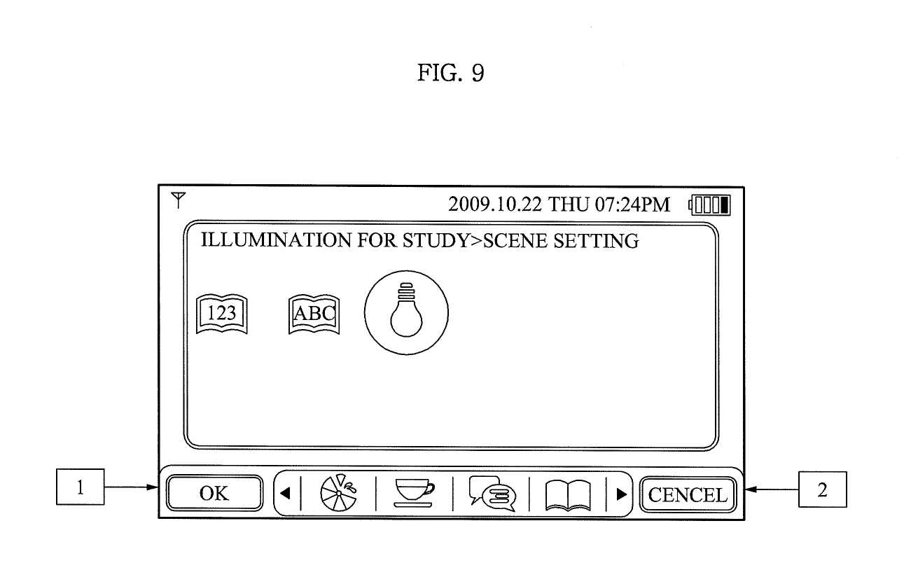

FIG. 9 shows a screen image for setting a scene of class/learning illumination. A scene setting button may be pressed to add, delete, and shift a scene icon. When the scene setting button is pressed, a scene setting menu appears at a lower portion of the screen, and a desired scene icon may be added or deleted by using the icon present on the scene setting menu. In this case, identification number 1 denotes storing a scene registered by an OK button and then shifting to a scene screen, and identification number 2 denotes canceling a registered scene by a cancel button and the shifting to a scene screen.

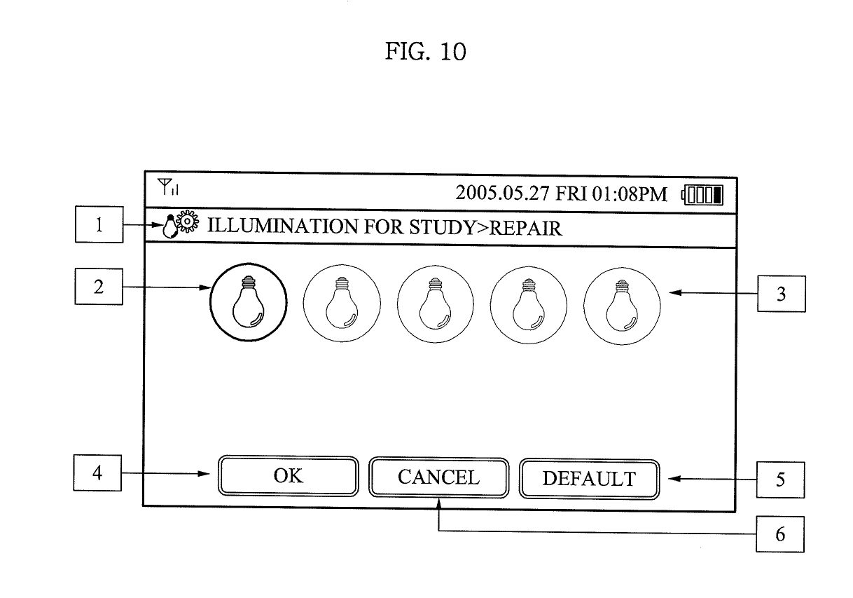

FIG. 10 shows a screen image of zone setting to be displayed when the scene icon is pressed for three seconds from the scene screen.

When zone is clicked once, a corresponding zone is turned on to check the location of the zone (scene). When zone is clicked once more, a current screen is shifted to a screen for setting the color of the corresponding zone.

Here, identification number 1 denotes a path of the current screen. Identification number 2 denotes zone location check state. Identification number 3 denotes a state in which a zone is not selected. Identification number 4 denotes a button for moving to a scene screen after storing a set zone. Identification number 5 denotes a button for canceling the set zone and moving to a previous screen. Identification number 6 denotes a button for returning to a default value. Identification number 6 can be applied when the identification number 4 or 5 is selected.

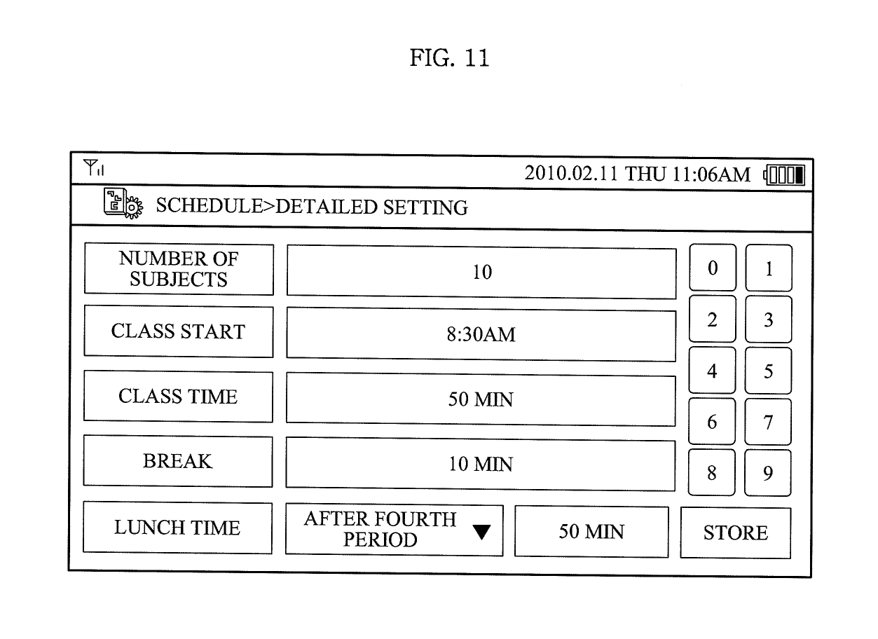

FIG. 11 shows a screen image including a schedule configured by inputting a subject for a corresponding time every weekday in the case of a school. A scene of illumination to be used for a corresponding time may be set simultaneously when subjects are configured. Namely, the schedule can be set by inputting the number of subjects, class start times, class times, break times, and lunch time.

The color and illumination scene of a subject, a classroom, a teacher, and a schedule can be set by clicking time on the schedule. Then, a scene connected to an icon is automatically set for a corresponding time. A break and a lunch time can be also set. In addition, a scheduling function can be activated or deactivated.

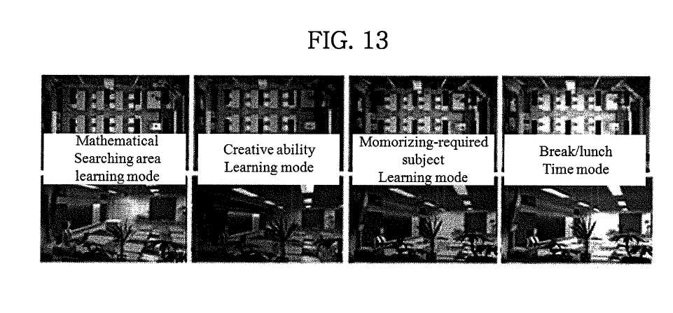

As shown in FIG. 13, a color temperature and brightness of the foregoing scene can be selected according to the characteristics of each subject. The color temperature may be adjusted by using an illumination device that can vary color temperature. The set schedule may be stored in a memory of the controller for controlling illumination, so that the set value can be maintained even when a battery is discharged or a user turns off power.

In case of the break and lunch time, color temperature and brightness can be automatically adjusted to obtain an energy saving effect. The schedule can be set without passing through a server, and the set time and scene are transmitted to the server so that the server can manage them. When the power of the controller for controlling illumination is turned off, the server or a gateway may serve as the controller instead. In this respect, when the controller for controlling illumination is turned off, the server or the gateway is informed accordingly, in order that the server or the gateway can perform scheduling.

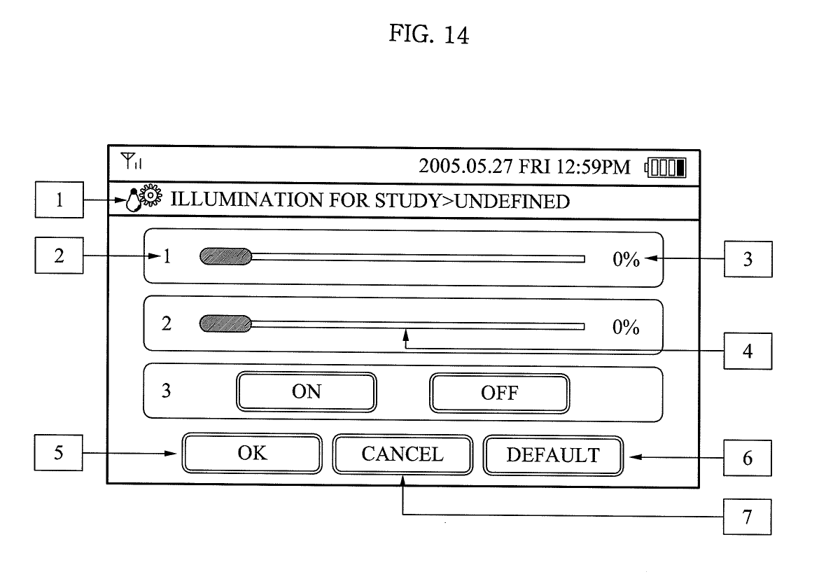

FIG. 14 shows a screen image in which, when the corresponding zone is double-clicked in the scene, the current image is moved to a zone setting screen image (namely, the zone setting screen image is displayed).

Here, identification number 1 denotes a path of the current screen. Identification number 2 denotes an LED number in the illumination device. Identification number 3 denotes brightness of the LED. Identification number 4 denotes a bar for setting the LED brightness. Identification number 5 denotes a button for moving to the zone screen image after storing the set LED. Identification number 6 denotes a button for moving to a previous screen after storing the LED as a default value. Identification number 7 denotes a button for storing the LED with a previous value before setting and maintaining the current screen.

As described above, the color temperature and brightness of illumination can be automatically adjusted according to situations and time, and thus, energy can be saved and a learning (or acquisition) effect can be improved.

As set forth above, according to exemplary embodiments of the invention, an illumination device participating in a wireless network can be controlled by setting an illumination scene according to a configurable schedule.

While the present invention has been shown and described in connection with the exemplary embodiments, it will be apparent to those skilled in the art that modifications and variations can be made without departing from the spirit and scope of the invention as defined by the appended claims.

What is claimed is:

1. A controller for controlling an illumination device, the controller comprising:
a control unit controlling an illumination scene of an illumination device selected from among a plurality of illumination devices existing in a pre-set network according to a pre-set schedule table;
a frame generation unit generating a frame for controlling the illumination scene of the corresponding illumination device under the control of the control unit; and
a communication unit transmitting the frame generated by the frame generation unit to the selected illumination device under the control of the controller.

2. The controller of claim 1, wherein the frame generation unit generates a control frame to be transmitted to the selected illumination device, and the control frame comprises an STX field indicating the start of the frame, a DataLen field indicating the length of information desired to be delivered, a Data field having information desired to be delivered, a Check Sum field for checking an error, and an ETX field indicating the end of the frame.

3. The controller of claim 2, wherein the data field comprises a Primitive ID including the purpose of transmitting information, a Device Address indicating the address of an illumination device desired to be delivered, a Command having a command to be delivered to the illumination device, and Command Data having data required for the command.

4. The controller of claim 3, wherein the command comprises a setting command, a transmission command, and a control command.

5. The controller of claim 4, wherein the plurality of devices comprises an illumination sensor and a motion sensor, and the setting command commands at least one of setting a parameter for a zone and controlling of the plurality of illumination devices, setting a function of a switch, setting a calibration parameter of the illumination sensor, setting an operation of the motion sensor, and setting a control element of the controller.

6. The controller of claim 5, wherein the transmission command commands the transmission of at least one of a parameter for a zone and controlling of the plurality of illumination device, a parameter set for a switch, a calibration parameter of the illumination sensor, at least one parameter among setting of an operation of the motion sensor and a control element of the controller, information regarding a state and the presence or absence of a failure, or databases of the plurality of devices.

7. The controller of claim 4, wherein the control command commands at least one of controlling a zone of the plurality of illumination devices and controlling the illumination devices by channels, individually controlling the plurality of illumination devices or controlling the illumination devices by channels, controlling of resetting of the plurality of illumination devices, and controlling illumination scenes of the plurality of illumination devices.
